(19) United States
(12) Patent Application Publication
(10) Pub. No.: US 2020/0255207 A1
(43) Pub. Date: Aug. 13, 2020

(54) REACTIVE CONTAINED LIQUID TRANSPORT APPARATUS

(71) Applicants: Jacob R. Gonce, Oklahoma City, OK (US); Brock A. Trotter, Norman, OK (US)

(72) Inventors: Jacob R. Gonce, Oklahoma City, OK (US); Brock A. Trotter, Norman, OK (US)

(21) Appl. No.: 16/273,962

(22) Filed: Feb. 12, 2019

(51) Int. Cl. B65D 81/36; B65D 81/38; F16C 19/08

(52) U.S. Cl. CPC B65D 81/365; B65D 81/3879; A63B 39/08; A63B 2243/0025; A63B 2225/682; F16C 19/08

(57) ABSTRACT

A contained reactive liquid transport apparatus is provided. The transport apparatus comprises a first part and a second part attachable to and detachable from one another, and a ball bearing assembly. The first and second parts each have an outer shell and extend around a common central axis to form a longitudinal chamber that can hold a contained reactive liquid. The ball bearing assembly allows the outer shells to rotate with respect to the longitudinal chamber and a contained reactive liquid held placed therein, thereby minimizing shaking or other agitation to the contained reactive liquid. In one embodiment, the transport apparatus is a combination sports ball and contained carbonated beverage transport apparatus.

### BACKGROUND

Various types of liquids are reactive in the sense that they undergo chemical reactions, vaporize or release a gas when they are shaken or otherwise agitated. For example, certain chemical compositions stored in containers and used in industry can become very volatile when agitated which, in some circumstances, can create a risk of explosion. Other types of reactive liquids can merely be a nuisance when they are shaken or agitated. Carbonated beverages fall into the second category.

A carbonated beverage is a beverage that contains dissolved carbon dioxide (CO₂). Examples of carbonated beverages are sodas such as soft drinks, beer and Champagne. Such beverages are typically placed in plastic or glass bottles, aluminum cans or other containers. Carbon dioxide is generally added to the containers, and the containers are sealed under pressure. Alcohol-containing beverages may also naturally contain carbon dioxide that is created during the fermentation process.

Carbon dioxide is only weakly soluble in water and therefore separates as a gas when the pressure is released. As a result, when a carbonated beverage container is opened, the pressure is removed and carbon dioxide is released from the beverage solution as small bubbles, which causes the solution to become effervescent, or fizzy. Eventually, most or all of the carbon dioxide is released causing the beverage to become flat. If the beverage is handled gently, this process will take some time.

However, if the beverage is shaken or otherwise agitated, the carbon dioxide can be released from the beverage at a relatively fast rate. The turbulence caused by the shaking or other agitation allows the carbon dioxide to more easily vaporize from the beverage. The released carbon dioxide vapor increases the pressure in the container. As a result, when the container is opened, the rapid release of the pressure can cause a significant part of the beverage to flow out of the container which can result in a waste of the beverage and create a mess.

Regardless of the type of contained liquid, reactive liquid containers often need to be transported, which can cause the liquids to be shaken or otherwise agitated. For example, various types of gases and chemical compositions are often contained by cylinders or vats that are placed on a truck or trailer and transported to an end-use location, for example, an oil and gas wellsite. The agitation to the gases or composition caused by the transportation process can be problematic.

As to carbonated beverages, it is often necessary or desirable for one person to throw or toss a contained beverage (for example, a can of soda) to another person, for example, a person in a pool or lake. This can also be problematic. First, the process of throwing or tossing the beverage can agitate the beverage and cause part of the beverage to be lost when the beverage is opened. Also, the beverage container can hit someone and cause injury thereto. Another potential problem is that if the beverage container lands in the water, the water can undesirably change the temperature of the beverage.

There is a need for a contained reactive liquid transport container that can eliminate or at least minimize these problems.

### SUMMARY

A contained reactive liquid transport apparatus is provided. The transport apparatus comprises a first part and a second part attachable to and detachable from one another, and a ball bearing assembly. The first and second parts each extend around a common central axis when attached to one another and include an outer shell that defines an inner cavity and includes an exterior surface and an interior surface, and a boundary member disposed within the inner cavity and defining an opening within the inner cavity. When the first and second parts are attached to one another, the outer shells, inner cavities, boundary members and openings all extend around and are centered on the common central axis such that the outer shells, inner cavities, boundary members and openings of the first part align with the corresponding outer shells, inner cavities, boundary members and openings of the second part and the openings form a longitudinal chamber that extends around the common central axis into each boundary member. When the first and second parts are detached from one another, the corresponding outer shells, inner cavities, boundary members and openings come apart to allow access to the longitudinal chamber whereby a liquid container can be inserted into one of the openings such that when the first and second parts are attached back together the liquid container will be contained within the longitudinal chamber. The ball bearing assembly is disposed between the interior surface of the outer shell and the exterior surface of the corresponding boundary member of at least one of the first and second parts, whereby the ball bearing assembly allows the outer shells of the first and second parts to rotate with respect to the boundary members and the longitudinal chamber when the first and second parts are attached to one another.

### BRIEF DESCRIPTION OF THE DRAWINGS

The drawings included with this application illustrate certain aspects of the embodiment described herein. However, the drawing should not be viewed as illustrating an exclusive embodiment. The subject matter disclosed is capable of considerable modifications, alterations, combinations, and equivalents in form and function, as will occur to those skilled in the art with the benefit of this disclosure.

FIG. 1 is a perspective view of one embodiment of the contained reactive liquid transport container disclosed herein, illustrated as containing a typical beverage container.

FIG. 2 is a front view of the embodiment of the contained reactive liquid transport container shown by FIG. 1.

FIG. 3A shows one embodiment of the contained reactive liquid transport container shown by FIGS. 1 and 2 when the first and second parts of the transport container are separated from one another.

FIG. 3B is a cross-sectional view taken along line 3B-3B of FIG. 1.

FIG. 3C is a cross-sectional view taken along line 3C-3C of FIG. 3A.

FIG. 3D is a cross-sectional view taken along line 3D-3D of FIG. 3A.

FIG. 4A shows another embodiment of the contained reactive liquid transport container shown by FIGS. 1 and 2 when the first and second parts of the transport container are separated from one another.

FIG. 4B is a cross-sectional view taken along line 4B-4B of FIG. 1.

FIG. 4C is a cross-sectional view taken along line 4C-4C of FIG. 4A.

FIG. 4D is a cross-sectional view taken along line 4D-4D of FIG. 4A.

FIG. 5A shows one configuration of an alternative embodiment of the ball bearing assembly used in the embodiment of the contained reactive liquid transport container shown by FIGS. 4A-4D.

FIG. 5B shows a second configuration of an alternative embodiment of the ball bearing assembly used in the embodiment of the contained reactive liquid transport container shown by FIGS. 4A-4D.

FIG. 5C shows a third alternative embodiment of the ball bearing assembly used in the embodiment of the reactive liquid transport container shown by FIGS. 4A-4D.

FIG. 6A shows an alternative embodiment of the reactive liquid transport container wherein the boundary members of each of the first and second parts is a separate enclosure.

FIG. 6B is a cross-sectional view taken along line 6B-6B of FIG. 6A.

### DETAILED DESCRIPTION

The present disclosure may be understood more readily by reference to this detailed description. Numerous specific details are set forth in order to provide a thorough understanding of the various embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein.

In accordance with this disclosure, a contained reactive liquid transport apparatus is provided. As used herein and in the appended claims, a reactive liquid means a liquid that can vaporize or otherwise release a gas when contained by a container if the container is shaken or otherwise agitated. Examples of reactive liquids include volatile liquids and carbonated beverages. A contained reactive liquid means a reactive liquid that is placed and sealed in a container. For example, a volatile liquid contained and sealed in a vat can vaporize if the vat is shaken or otherwise agitated. For example, a carbonated beverage contained in a 12 ounce aluminum can release carbon dioxide if the can is shaken or otherwise agitated.

The contained reactive liquid transport apparatus can be used in any application in which it is desired to minimize shaking or other agitation of the container or reactive liquid. For example, in one application, the contained reactive liquid transport apparatus is useful for transporting a metal vat that contains a volatile chemical composition. The contained reactive liquid transport container minimizes shaking and/or other agitation of the vat and volatile liquid therein due to road vibrations, bumps in the road, potholes, inclines, sharp turns and the like. For example, in this application, the contained reactive liquid transport container can be of a shape and form that allows it to be placed on the back of a truck or on a trailer. For example, in another application, the contained reactive liquid transport apparatus is useful for transporting a carbonated beverage from one person to another. For example, in this application, the contained reactive liquid transport container can be of a shape and form that allows it to be thrown or tossed like a sports ball.

Referring now to the drawings, one embodiment of the contained reactive liquid transport apparatus disclosed herein, generally designated by the numeral 10, will be described. In this embodiment, the liquid transport apparatus is in the shape and form of a combination sports ball and contained carbonated beverage transport apparatus, namely, an American football.

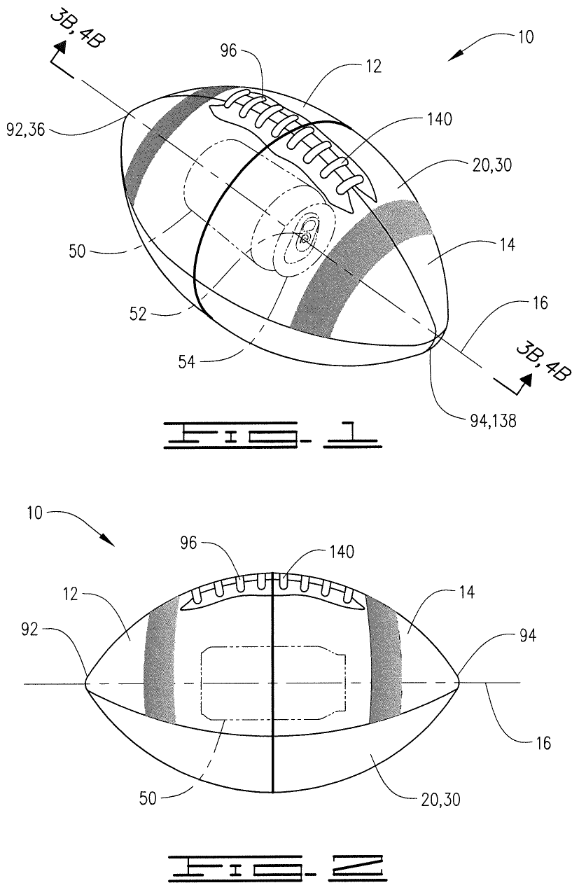

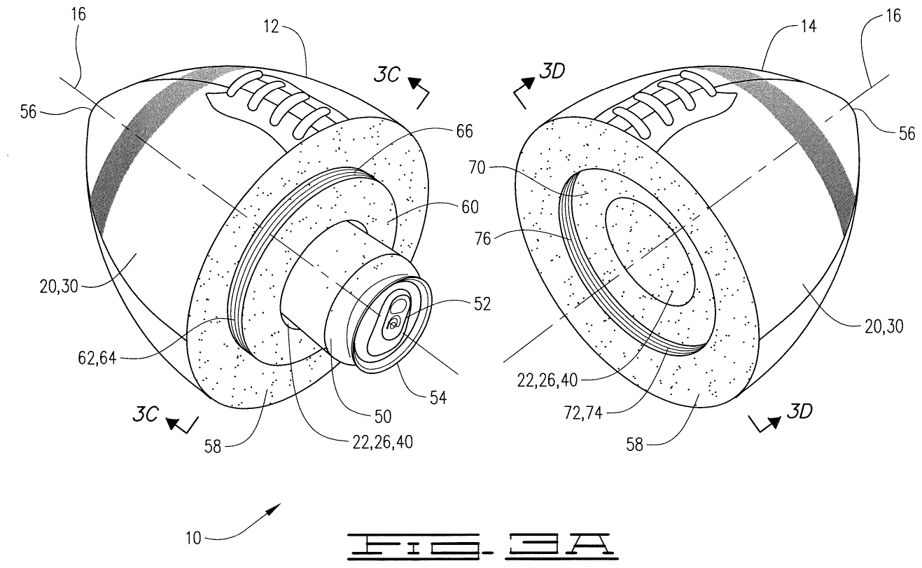

FIGS. 1, 2, 3A, 3B, 3C and 3D illustrate one embodiment of the contained reactive liquid transport apparatus 10. In this embodiment, the contained reactive liquid transport apparatus 10 comprises a first part 12 and a second part 14 that are attachable to and detachable from one another. Each of the first and second parts 12 and 14 extend around a common central axis 16 when attached to one another, and includes an outer shell 20 that defines an inner cavity 22, and a boundary member 24 disposed within the inner cavity 22 and defining an opening 26 within the inner cavity 22. The outer shell 20 includes an exterior surface 30 and an interior surface 32.

When the first and second parts 12 and 14 of the apparatus 10 are attached to one another, the outer shells 20, inner cavities 22, boundary members 24 and openings 26 all extend around and are centered on the common central axis 16 such that the outer shells 20, inner cavities 22, boundary members 24 and openings 26 of the first part 12 align with the corresponding outer shells 20, inner cavities 22, boundary members 24 and openings 26 of the second part 14 and the openings 26 form a longitudinal chamber 40 that extends around the common central axis 16 into each boundary member 24.

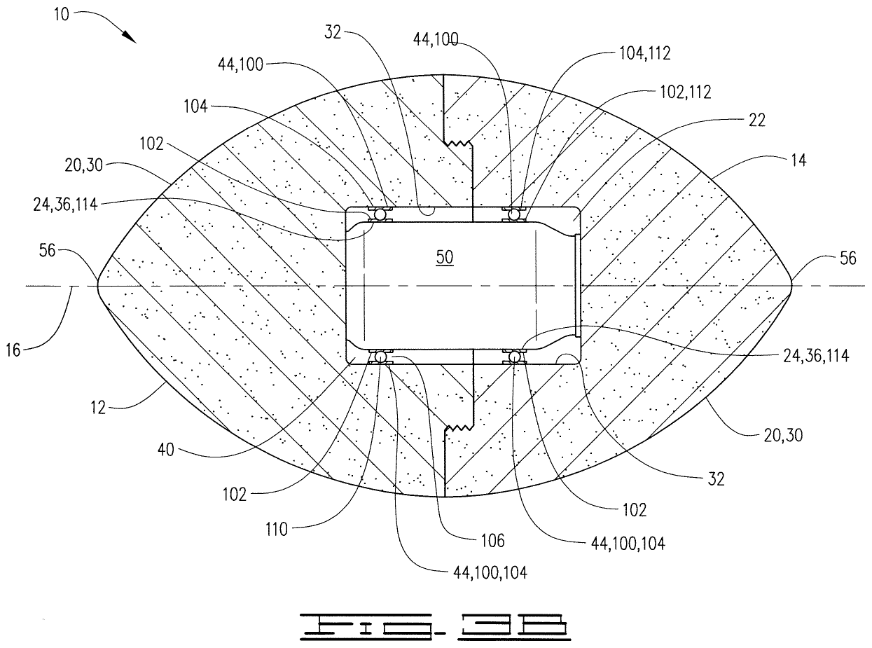

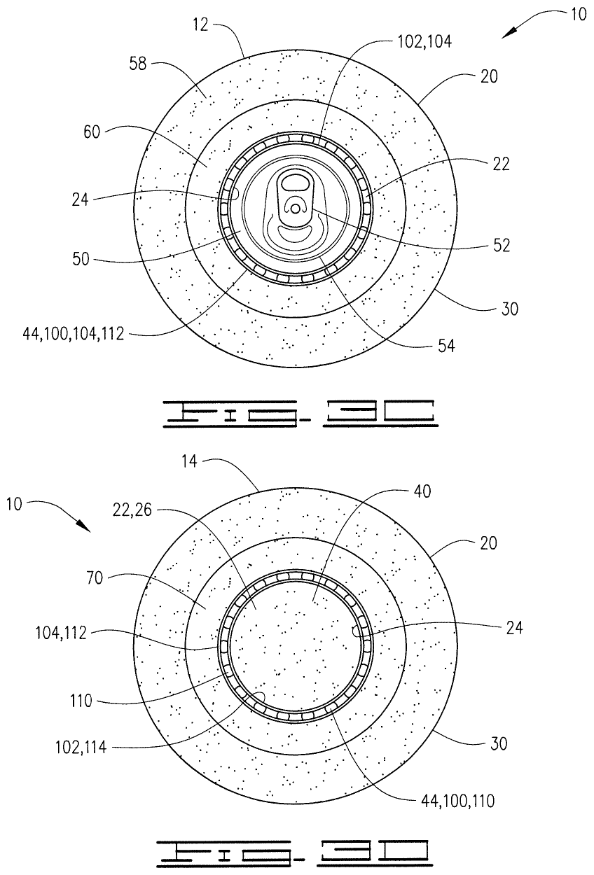

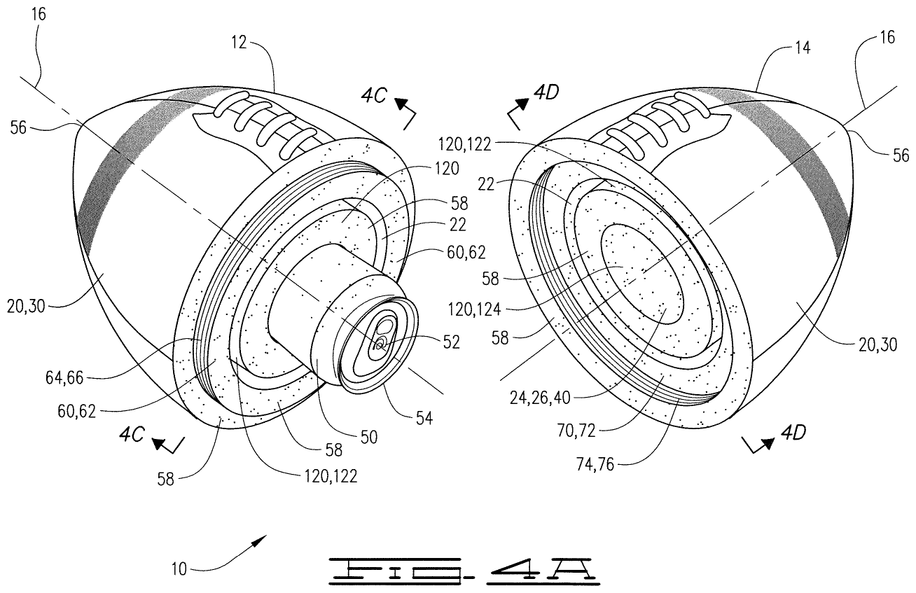

As shown by FIG. 3A, when the first and second parts 12 and 14 are detached from one another, the corresponding outer shells 20, inner cavities 22, boundary members 24 and openings 26 come apart to allow access to the longitudinal chamber 40 whereby a liquid container can be inserted into one of the openings 26 such that when the first and second parts 12 and 14 are attached back together, the liquid container will be contained within the longitudinal chamber 40. This allows a reactive liquid container 50 to be inserted into one of the openings 26 such that when the first and second parts 12 and 14 of the transport apparatus 10 are attached back together, the liquid container 50 will be contained within the longitudinal chamber 40. For example, as shown the openings 26 and longitudinal chamber are configured to receive a cylindrical reactive liquid container.

For example, as shown, the carbonated beverage container 50 is a standard 12 ounce cylindrical, aluminum can 50 having a pull tab 52 opening on its top 54. For example, the carbonated beverage container can also be a standard 16 ounce cylindrical, aluminum can having a pull tab opening on its top, or a standard 12 ounce or 16 ounce cylindrical, plastic bottle.

As best shown by FIGS. 3B, 3C and 3D, a ball bearing assembly 44 is disposed between the interior surface 32 of the outer shell 12 and the corresponding boundary member 24 of each of the first and second parts 12 and 14. The ball bearing assemblies 44 allow the outer shells 20 of the first and second parts 12 and 14 to rotate with respect to the boundary members 24 and the longitudinal chamber 40 when the first and second parts 12 and 14 are attached to one another.

Each of the first and second parts 12 and 14 of the transport apparatus 10 include a distal end 56 and a near end 58. The near ends 58 of the first and second parts 12 and 14 contact one another when the first and second parts are attached to one another. Each of the near ends 58 extends around and is centered on the common central axis 16 and the corresponding opening 26.

The near end 58 of the first part 12 includes a raised portion 60 that forms a male thread assembly 62. The male thread assembly 62 includes an outer wall 64 having a plurality of threads 66 disposed thereon. The near end 58 of the second part 14 includes a corresponding inset portion 70 that forms a female thread assembly 72. The female thread assembly 72 includes an inner wall 74 that has a plurality of threads 76 disposed therein. The threads 66 of the male thread assembly 62 correspond to and match the threads 76 of the female thread assembly 72 and allow the first and second parts 12 and 14 to be threadedly connected together. For example, the male thread assembly 62 can be rotated clockwise into the female thread assembly 72 and tightly secured therein such that the first parts 12 and 14 become connected and are held together. Due to the interlocking nature of the male and female thread assemblies 62 and 72, when the first and second parts 12 and 14 of the reactive liquid transport apparatus 10 are tightly attached to one another, the outer shells 20 of the first and second parts 12 and 14 are held together such that rotation of one of the outer shells around the common central axis 16 causes the corresponding outer shell to also rotate around the common central axis in conjunction therewith. Also, a watertight and secure seal between the first and second parts 12 and 14 is provided. Similarly, the male thread assembly 62 can subsequently be rotated counterclockwise within the female thread assembly 72 to detach the first part 12 from the second part 14.

Each of the ball bearing assemblies 44 comprises a ball bearing set 100. The ball bearing set 100 includes an inside annular track member 102 that extends around the common central axis 16, and an outside annular track member 104 that extends around the common central axis 16 and is spaced from the inside annular track member to form an annular space 106 between the first and second annular track members 102 and 104. A plurality of round balls 110 are freely disposed in the annular space 106, whereby the balls 110 contact both the inside annular track member 102 and the outside annular track member 104 and allow the inside and outside track members 102 and 104 to rotate with respect to one another. The inside and outside annular track members 102 and 104 each have an outside surface 112 and an inside surface 114. The outside surface 112 of the inside annular track member 102 and the inside surface 114 of the outside annular track member 104 both contact the balls 110. As used herein and in the appended claims, “freely disposed in the annular space” means disposed in the annular space in a manner that lets the balls rotate in the annular space with respect to one another and with respect to each of the first and second annular track members 102 and 104. For example, the ball bearing set 100, including the track members 102 and 104 and the balls 110, can be formed of a solid metal such as steel or a ceramic material.

In the embodiment shown by FIGS. 3B, 3C and 3D, the boundary member 24 of each of the first and second parts 12 and 14 of the transport apparatus 10 is the inside surface 114 of the inside annular track member 102 of the ball bearing set 100 of the corresponding ball bearing assembly 44 such that when the first and second parts are attached to one another, the inside surfaces of the first annular track members define the longitudinal chamber 40.

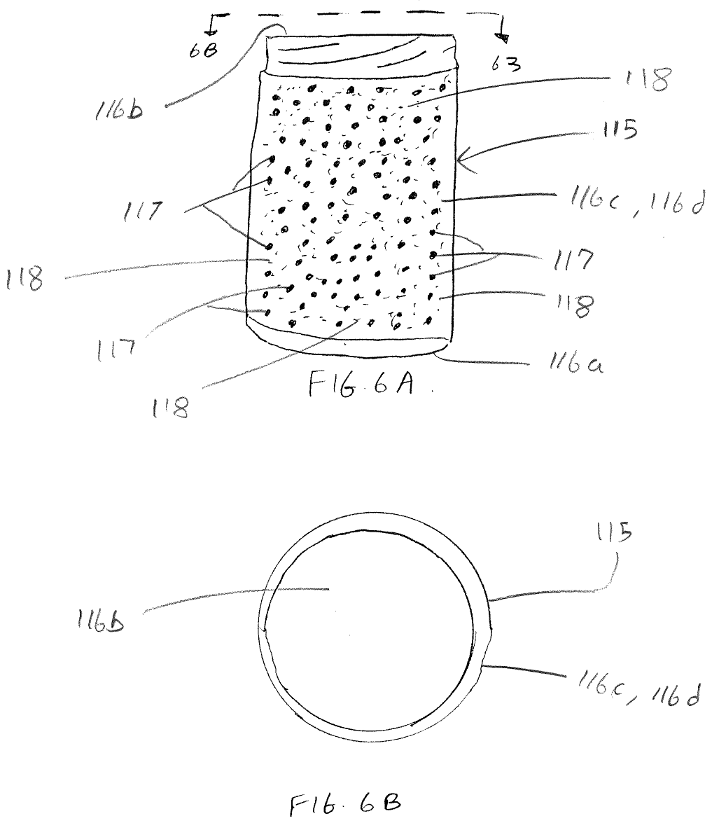

Referring to FIGS. 6A and 6B, in another embodiment, the boundary member 24 of each of the first and second parts 12 and 14 of the transport apparatus 12 is a separate enclosure 115 having a bottom 116a, an open top 116b and a cylindrical wall 116c connecting the bottom and said top together such that when said first and second parts are attached to one another said open tops mate together to form the longitudinal chamber 40. The cylindrical wall 116c has an outside surface 116d. A plurality of raised portions or ribs 117 are disposed on (for example, molded on to) to the outside surface 116d, and an adhesive layer 118 is placed on the outside surface 118 on top of the ribs 117. The outside surface 118 of the cylindrical wall can be attached to the inside surfaces 114 of the inside annular track members 102 of the ball bearing sets 100.

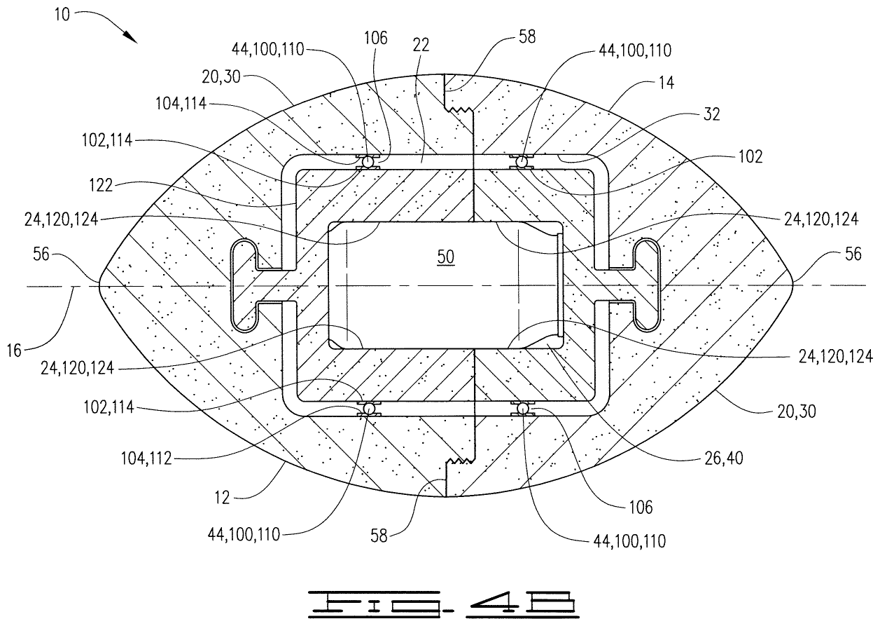

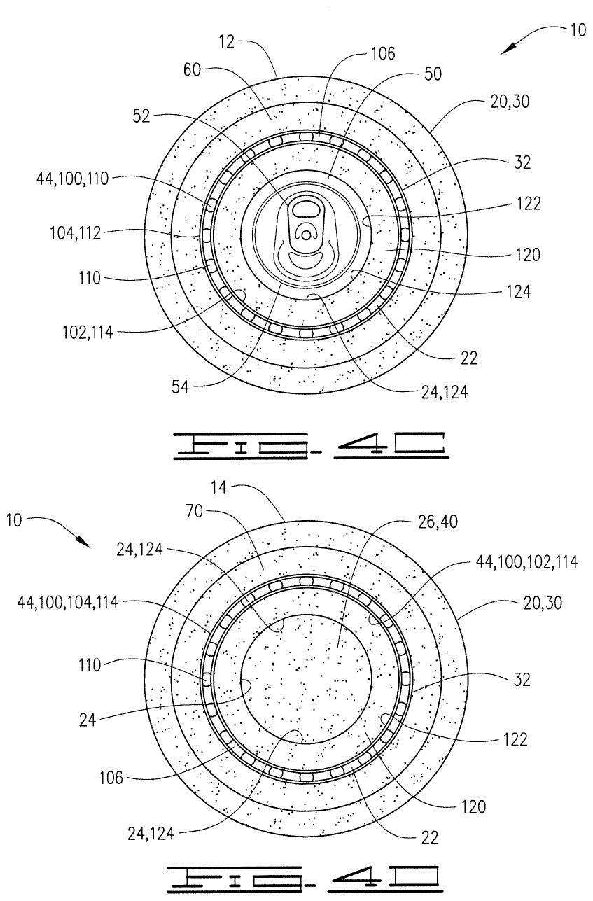

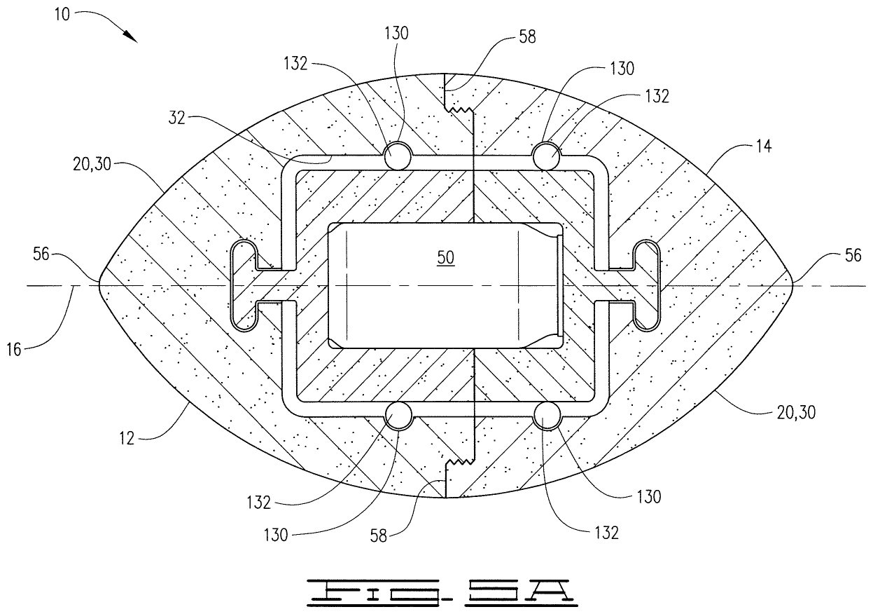

FIGS. 1, 2, 4A, 4B, 4C, 4D, 5A, 5B and 5C illustrate a second embodiment of the contained reactive liquid transport apparatus 10. In this embodiment, the first and second parts 12 and 14 of the reactive liquid transport apparatus 10 each further comprise an inner shell 120 disposed in the inner cavity 22 between the corresponding outer shell 20 and boundary member 24. Each of the inner shells 120 includes an exterior surface 122 and an interior surface 124. When the first and second parts 12 and 14 are attached to one another, the inner shells 120 extend around the common central axis 16 and are in alignment with one another. As best shown by FIG. 4A, when the first and second parts 12 and 14 are detached from one another, the corresponding inner shells 120 also come apart to allow access to the longitudinal chamber 40.

The ball bearing assembly 44 is disposed between the interior surface 32 of the outer shell 20 and the exterior surface 122 of the corresponding inner shell 120 of each of the first and second parts. The ball bearing assembly 44 allows the outer shells of the first and second parts to rotate around the common central axis with respect to the inner shells, the boundary members and the longitudinal chamber when the first and second parts are attached to one another.

In this embodiment, the boundary member 24 of each of the first and second parts 12 and 14 is the interior surface 124 of the corresponding inner shell 120. Due to the interlocking nature of the male and female thread assemblies 62 and 72, when the first and second parts 12 and 14 of the reactive liquid transport apparatus 10 are tightly attached to one another in a watertight manner, the outer shells 20 of the first and second parts 12 and 14 are held together such that rotation of one of the outer shells around the common central axis 16 causes the corresponding outer shell to also rotate around the common central axis in conjunction therewith.

In the embodiment shown by FIGS. 4B, 4C and 4D, the ball bearing assemblies 44 are the same as the ball bearing assemblies 44 in the first embodiment shown by FIGS. 3B, 3C and 3D. Specifically, each of the ball bearing assemblies 44 comprises a ball bearing set 100. The ball bearing set 100 includes an inside annular track member 102 that extends around the common central axis 16, and an outside annular track member 104 that extends around the common central axis 16 and is spaced from the inside annular track member to form an annular space 106 between the first and second annular track members 102 and 104. A plurality of round balls 110 are freely disposed in the annular space 106, whereby the balls 110 contact both the inside annular track member 102 and the outside annular track member 104 and allow the inside and outside track members 102 and 104 to rotate with respect to one another.

The inside surface 114 of the inside annular track member 102 of the ball bearing set 100 of each of the ball bearing assemblies 44 is disposed adjacent to the exterior surface 122 of the corresponding inner shell 120, and the outside surface 112 of the outside annular track member 104 is disposed adjacent to the interior surface 32 of the outer shell 20.

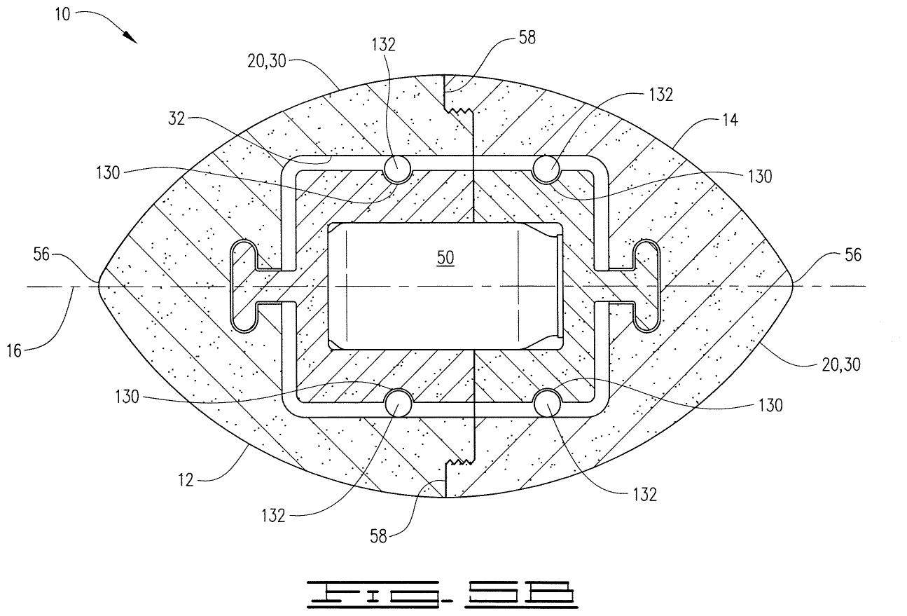

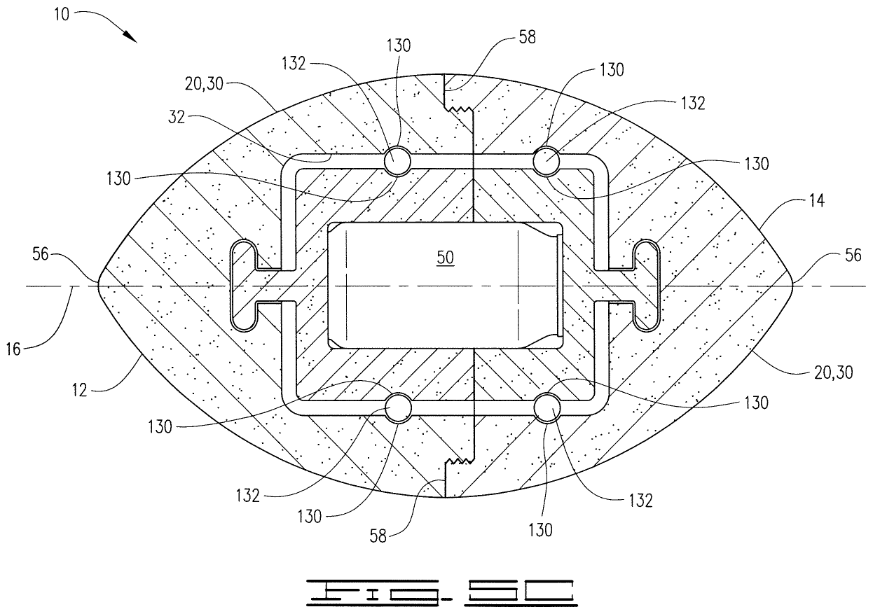

FIGS. 5A, 5B and 5C illustrate an alternative embodiment of the ball bearing assembly 44 for use in connection with the second embodiment of the contained reactive liquid transport apparatus 10. In this embodiment, the outer shells 20 and/or inner shells 120 are a part of the ball bearing assemblies 44. Specifically, with respect to each of the first and second parts 12 and 14, at least one of the interior surface 32 of the outer shell 20 and the exterior surface 122 of the inner shell 120 has a groove 130 disposed therein. The corresponding ball bearing assembly 44 includes (a) the groove(s) 130, (b) a portion of the other of the interior surface 32 of the outer shell 20 and the exterior surface 122 of the inner shell 120 that opposes the groove(s) 130, and (c) a plurality of round balls 132 freely disposed in the groove(s) 130. The balls 132 have a size sufficient to space the interior surface 32 of the outer shell 20 from the exterior surface 122 of the inner shell 120 and allow the outer shell 20 to rotate with respect to the inner shell 120 and the internal chamber 40. For example, the balls 132 can be formed of steel or ceramic.

As shown by FIG. 5A, a groove 130 is disposed in the interior surface 32 of the outer shell 20. As shown by FIG. 5B, a groove 130 is disposed in the exterior surface 122 of the inner shell 120. As shown by FIG. 5C, a separate groove 130 is disposed in both the interior surface 32 of the outer shell 20 and the exterior surface 122 of the inner shell 120.

In the embodiment shown by the drawings, the reactive liquid transport apparatus 10 is a combination sports ball and contained carbonated beverage transport apparatus. In this embodiment, the outer shells 20 of the transport apparatus 10 have a size, shape and texture that allow the apparatus to function as both a sports ball and a contained carbonated beverage transport apparatus.

For example, as shown by the drawings, the outer shells 20 have an oval shape and a size and texture that allow the apparatus to function as both an American football and a contained carbonated beverage transport apparatus. As shown, the transport apparatus 10 has a first end 136, a second end 138 and a simulated lace 140. The first and second parts 12 and 14 of the transport apparatus 10 can be detached, and a contained carbonated beverage (for example, a 12 ounce aluminum can of beer or plastic bottle of soda) can be placed in one of the openings 26. The first and second parts 12 and 14 can then be attached together whereby the contained carbonated beverage is protected and insulated in the longitudinal chamber 40.

The transport apparatus 10 can then be thrown like a football, for example, from one person in a boat to another person swimming in a lake. When properly thrown, the outer shells 12 of the transport apparatus 10 spin around the common central axis 16 with respect to the longitudinal chamber 40 and the contained carbonated beverage 50. This allows the transport apparatus 10 to be thrown in a spiral like a regular American football without imparting the same spinning motion to the contained carbonated beverage. As a result, shaking and agitation of the contained carbonated beverage is minimized thereby minimizing the loss of a portion of the carbonated beverage when the container is opened.

For example, the outer shells 20 and inner shells 120 of the transport apparatus 10 can be made of a material that insulates the carbonated beverage, helps prevent injury and causes the transport apparatus to float on water. For example, the outer shells 20 and inner shells 120 can be made of a foam material. The foam material insulates the contained carbonated beverage from temperature changes due to the temperature of the water and also minimizes the risk of injury due to the transport apparatus hitting, for example, the face or head of a user or someone nearby. The foam material also causes the transport apparatus to float on water.

Therefore, the present transport apparatus is well adapted to attain the ends and advantages mentioned, as well as those that are inherent therein. The particular examples disclosed above are illustrative only, as the apparatus may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present process and system. While the present apparatus and components thereof may be described in terms of “comprising,” “containing,” “having,” or “including” various steps or components, the apparatus can also, in some examples, “consist essentially of” or “consist” of the various steps and components. Also, the terms in the claims have their plain, ordinary meaning unless otherwise explicitly and clearly defined by the patentee.

What is claimed is:

1. A contained reactive liquid transport apparatus, comprising:
a first part and a second part attachable to and detachable from one another, each of said first and second parts extending around a common central axis when attached to one another and including:
an outer shell that defines an inner cavity and includes an exterior surface and an interior surface; and
a boundary member disposed within said inner cavity and defining an opening within said inner cavity;
wherein when said first and second parts are attached to one another, said outer shells, inner cavities, boundary members and openings all extend around and are centered on said common central axis such that said outer shells, inner cavities, boundary members and openings of said first part align with said corresponding outer shells, inner cavities, boundary members and openings of said second part and said openings form a longitudinal chamber that extends around said common central axis into each boundary member; and
wherein when said first and second parts are detached from one another, said corresponding outer shells, inner cavities, boundary members and openings come apart to allow access to said longitudinal chamber whereby a liquid container can be inserted into one of said openings such that when said first and second parts are attached back together said liquid container will be contained within said longitudinal chamber; and
a ball bearing assembly disposed between said interior surface of said outer shell and said corresponding boundary member of at least one of said first and second parts, whereby said ball bearing assembly allows said outer shells of said first and second parts to rotate with respect to said boundary members and said longitudinal chamber when said first and second parts are attached to one another.

2. The contained reactive liquid transport apparatus of claim 1, wherein when said first and second parts are attached to one another, said outer shells are held together such that rotation of one of said outer shells around said central longitudinal axis causes the corresponding outer shell to also rotate around the common central axis in conjunction therewith.

3. The contained reactive liquid transport apparatus of claim 1, wherein a ball bearing assembly is disposed between said interior surface of said outer shell and said corresponding boundary member of each of said first and second parts, whereby said ball bearing assemblies allow said outer shells said first and second parts to rotate with respect to said boundary members and said longitudinal chamber when said first and second parts are attached to one another.

4. The contained reactive liquid transport apparatus of claim 3, wherein each of said ball bearing assemblies comprises a ball bearing set, said ball bearing set including:
an inside an annular track member extending around said common central axis;
an outside annular track member extending around said common central axis and spaced from said inside annular track member to form an annular space between said first and second annular track members; and
a plurality of round balls freely disposed in said annular space, whereby said balls contact both said inside annular track member and said outside annular track member and allow said inside and outside track members to rotate with respect to one another, wherein said first and second annular track members each have an outside surface and an inside surface; and
wherein said boundary member of each of said first and second parts is said inside surface of said inside annular track member of said ball bearing set of said corresponding ball bearing assembly such that when said first and second parts are attached to one another said inside surfaces of said first annular track members define said longitudinal chamber.

5. The contained reactive liquid transport apparatus of claim 1, wherein:
each of said first and second parts further comprises an inner shell disposed in said inner cavity between said outer shell and said boundary member, each of said inner shells including an exterior surface and an interior surface, wherein when said first and second parts are attached to one another, said inner shells extend around said common central axis and are in alignment with one another; and
said ball bearing assembly is disposed between said interior surface of said outer shell and said exterior surface of said corresponding inner shell of at least one of said first and second parts, whereby said ball bearing assembly allows said outer shells of said first and second parts to rotate around said common central axis with respect to said inner shells, said boundary members and said longitudinal chamber when said first and second parts are attached to one another.

6. The contained reactive liquid transport apparatus of claim 5, wherein said boundary member of each of said first and second parts is said interior surface of said inner shell.

7. The reactive liquid transport container of claim 5, wherein said boundary member of each of said first and second parts is an enclosure having a bottom, an open top and a cylindrical wall connecting said bottom and said top together such that when said first and second parts are attached to one another said open tops mate together to form said longitudinal chamber.

8. The contained reactive liquid transport apparatus of claim 5, wherein when said first and second parts are attached to one another, said outer shells are held together such that rotation of one of said outer shells around said central longitudinal axis causes the corresponding outer shell to also rotate around the common central axis in conjunction therewith.

9. The contained reactive liquid transport apparatus of claim 5, wherein a ball bearing assembly is disposed between said interior surface of said outer shell and said exterior surface of said corresponding inner shell of each of said first and second parts, whereby said ball bearing assemblies allow said outer shells of said first and second parts to rotate with respect to said inner shells, boundary members and said longitudinal chamber when said first and second parts are attached to one another.

10. The contained reactive liquid transport apparatus of claim 9, wherein each of said ball bearing assemblies comprises a ball bearing set, said ball bearing set including:
an inside an annular track member extending around said common central axis;
an outside annular track member extending around said common central axis and spaced from said inside annular track member to form an annular space between said first and second annular track members; and
a plurality of round balls freely disposed in said annular space, whereby said balls contact both said inside annular track member and said outside annular track member and allow said inside and outside track members to rotate with respect to one another, wherein said first and second annular track members each have an outside surface and an inside surface; and
wherein said inside surface of said inside annular track member of said ball bearing set of each of said ball bearing assemblies is disposed adjacent to said exterior surface of said corresponding inner shell, and said outside surface of said outside annular track member is disposed adjacent to said interior surface of said outer shell.

11. The contained reactive liquid transport apparatus of claim 9, wherein with respect to each of said first and second parts, at least one of said interior surface of said outer shell and said exterior surface of said inner shell has a groove disposed therein, and wherein said corresponding ball bearing assembly includes (a) said groove(s), (b) a portion of the other of said interior surface of said outer shell and said exterior surface of said inner shell that opposes said groove(c), and (c) a plurality of round balls freely disposed in said groove(s), said balls having a size sufficient to space said interior surface of said outer shell from said exterior surface of said inner shell and allow said outer shell to rotate with respect to said inner shell and said internal chamber.

12. The contained reactive liquid transport apparatus of claim 9, wherein said groove is disposed in said interior surface of said outer shell.

13. The contained reactive liquid transport apparatus of claim 9, wherein said groove is disposed in said exterior surface of said inner shell.

14. The contained reactive liquid transport apparatus of claim 9, wherein a separate groove is disposed in both the interior surface of the outer shell and the exterior surface of the inner shell.

15. The contained reactive liquid transport apparatus of claim 1, wherein said longitudinal chamber is configured to receive a cylindrical reactive liquid container.

16. The contained reactive liquid transport apparatus of claim 1, wherein said outer shells have a size, shape and texture that allow said apparatus to function as both a sports ball and a contained carbonated beverage transport apparatus.

17. The contained reactive liquid transport apparatus of claim 1, wherein said outer shells have an oval shape and a size and texture that allow said apparatus to function as both an American football and a carbonated beverage transport apparatus.

18. The contained reactive liquid transport apparatus of claim 1, wherein said liquid transport apparatus floats on water.

19. The contained reactive liquid transport apparatus of claim 1, wherein said outer shells of said first and second parts are made of a foam material.

20. The contained reactive liquid transport apparatus of claim 5, wherein said outer shells and said inner shells of said first and second parts are made of a foam material.

21. A combination sports ball and contained carbonated beverage transport apparatus, comprising:
a first part and a second part attachable to and detachable from one another, each of said first and second parts extending around a common central axis when attached to one another and including:
an outer shell that defines an inner cavity and includes an exterior surface and an interior surface; and
a boundary member disposed within said inner cavity and defining an opening within said inner cavity;
wherein when said first and second parts are attached to one another, said outer shells, inner cavities, boundary members and openings all extend around and are centered on said common central axis such that said outer shells, inner cavities, boundary members and openings of said first part align with said corresponding outer shells, inner cavities, boundary members and openings of said second part and said openings form a longitudinal chamber that extends around said common central axis into each boundary member; and
wherein when said first and second parts are detached from one another, said corresponding outer shells, inner cavities, boundary members and openings come apart to allow access to said longitudinal chamber whereby a liquid container can be inserted into one of said openings such that when said first and second parts are attached back together said liquid container will be contained within said longitudinal chamber, wherein said outer shells have a size, shape and texture that allow said apparatus to function as both a sports ball and a contained carbonated beverage transport apparatus; and
a ball bearing assembly disposed between said interior surface of said outer shell and said corresponding boundary member of at least one of said first and second parts, whereby said ball bearing assembly allows said outer shells of said first and second parts to rotate with respect to said boundary members and said longitudinal chamber when said first and second parts are attached to one another.

22. The combination sports ball and contained carbonated beverage transport apparatus of claim 21, wherein when said first and second parts are attached to one another, said outer shells are held together such that rotation of one of said outer shells around said central longitudinal axis causes the corresponding outer shell to also rotate around the common central axis in conjunction therewith.

23. The combination sports ball and contained carbonated beverage transport apparatus of claim 21, wherein a ball bearing assembly is disposed between said interior surface of said outer shell and said corresponding boundary member of each of said first and second parts, whereby said ball bearing assemblies allow said outer shells said first and second parts to rotate with respect to said boundary members and said longitudinal chamber when said first and second parts are attached to one another.

24. The combination sports ball and contained carbonated beverage transport apparatus of claim 23, wherein each of said ball bearing assemblies comprises a ball bearing set, said ball bearing set including:
an inside an annular track member extending around said common central axis;
an outside annular track member extending around said common central axis and spaced from said inside annular track member to form an annular space between said first and second annular track members; and
a plurality of round balls freely disposed in said annular space, whereby said balls contact both said inside annular track member and said outside annular track member and allow said inside and outside track members to rotate with respect to one another, wherein said first and second annular track members each have an outside surface and an inside surface; and
wherein said boundary member of each of said first and second parts is said inside surface of said inside annular track member of said ball bearing set of said corresponding ball bearing assembly such that when said first and second parts are attached to one another said inside surfaces of said first annular track members define said longitudinal chamber.

25. The combination sports ball and contained carbonated beverage transport apparatus of claim 21, wherein:
each of said first and second parts further comprises an inner shell disposed in said inner cavity between said outer shell and said boundary member, each of said inner shells including an exterior surface and an interior surface, wherein when said first and second parts are attached to one another, said inner shells extend around said common central axis and are in alignment with one another; and
said ball bearing assembly is disposed between said interior surface of said outer shell and said exterior surface of said corresponding inner shell of at least one of said first and second parts, whereby said ball bearing assembly allows said outer shells of said first and second parts to rotate around said common central axis with respect to said inner shells, said boundary members and said longitudinal chamber when said first and second parts are attached to one another.

26. The combination sports ball and contained carbonated beverage transport apparatus of claim 25, wherein said boundary member of each of said first and second parts is said interior surface of said inner shell.

27. The combination sports ball and contained carbonated beverage transport container of claim 25, wherein said boundary member of each of said first and second parts is an enclosure having a bottom, an open top and a cylindrical wall connecting said bottom and said top together such that when said first and second parts are attached to one another said open tops mate together to form said longitudinal chamber.

28. The combination sports ball and contained carbonated beverage transport apparatus of claim 25, wherein when said first and second parts are attached to one another, said outer shells are held together such that rotation of one of said outer shells around said central longitudinal axis causes the corresponding outer shell to also rotate around the common central axis in conjunction therewith.

29. The combination sports ball and contained carbonated beverage transport apparatus of claim 25, wherein a ball bearing assembly is disposed between said interior surface of said outer shell and said exterior surface of said corresponding inner shell of each of said first and second parts, whereby said ball bearing assemblies allow said outer shells of said first and second parts to rotate with respect to said inner shells, boundary members and said longitudinal chamber when said first and second parts are attached to one another.

30. The combination sports ball and contained carbonated beverage transport apparatus of claim 29, wherein each of said ball bearing assemblies comprises a ball bearing set, said ball bearing set including:
an inside an annular track member extending around said common central axis;
an outside annular track member extending around said common central axis and spaced from said inside annular track member to form an annular space between said first and second annular track members; and
a plurality of round balls freely disposed in said annular space, whereby said balls contact both said inside annular track member and said outside annular track member and allow said inside and outside track members to rotate with respect to one another, wherein said first and second annular track members each have an outside surface and an inside surface; and
wherein said inside surface of said inside annular track member of said ball bearing set of each said ball bearing assemblies is disposed adjacent to said exterior surface of said corresponding inner shell, and said outside surface of said outside annular track member is disposed adjacent to said interior surface of said outer shell.

31. The combination sports ball and contained carbonated beverage transport apparatus of claim 29, wherein with respect to each of said first and second parts, at least one of said interior surface of said outer shell and said exterior surface of said inner shell has a groove disposed therein, and wherein said corresponding ball bearing assembly includes (a) said groove(s), (b) a portion of the other of said interior surface of said outer shell and said exterior surface of said inner shell that opposes said groove(c), and (c) a plurality of round balls freely disposed in said groove(s), said balls having a size sufficient to space said interior surface of said outer shell from said exterior surface of said inner shell and allow said outer shell to rotate with respect to said inner shell and said internal chamber.

32. The combination sports ball and contained carbonated beverage transport apparatus of claim 29, wherein said groove is disposed in said interior surface of said outer shell.

33. The combination sports ball and contained carbonated beverage transport apparatus 29, wherein said groove is disposed in said exterior surface of said inner shell.

34. The combination sports ball and contained carbonated beverage transport apparatus of claim 29, wherein a separate groove is disposed in both the interior surface of the outer shell and the exterior surface of the inner shell.

35. The combination sports ball and contained carbonated beverage transport apparatus of claim 21, wherein said longitudinal chamber is configured to receive a cylindrical reactive liquid container.

36. The combination sports ball and contained carbonated beverage transport apparatus of claim 21, wherein said outer shells have an oval shape and a size and texture that allow said apparatus to function as both an American football and a carbonated beverage transport apparatus.

37. The combination sports ball and contained carbonated beverage transport apparatus of claim 21, wherein said beverage transport apparatus floats on water.

38. The combination sports ball and contained carbonated beverage transport apparatus of claim 21, wherein said outer shells of said first and second parts are made of a foam material.

39. The combination sports ball and contained carbonated beverage transport apparatus claim 25, wherein said outer shells and said inner shells of said first and second parts are made of a foam material.
